(19) United States
(12) Patent Application Publication
(10) Pub. No.: US 2006/0065348 A1
(43) Pub. Date: Mar. 30, 2006

(54) Apparatus and method for fiber fusing a surface of woven and non-woven fabrics

(76) Inventor: Emmanuel P. Kargiatlis, Chesnee, SC (US)

Correspondence Address: PEARSON & PEARSON, LLP, 10 GEORGIA STREET, LOWELL, MA, 01852, US

(21) Appl. No.: 11/228,718

(22) Filed: Sep. 16, 2005

Related U.S. Application Data
(60) Provisional application No. 60/611,499, filed on Sep. 20, 2004.
(60) Provisional application No. 60/616,019, filed on Oct. 5, 2004.

(51) Int. Cl. B29C 67/00; B29C 43/22; B29C 71/00; B32B 37/00

(52) U.S. Cl. 156/82; 264/80; 264/280; 264/348; 156/497

(57) ABSTRACT

An apparatus and method for producing a non-woven fabric made from a web having a combination of synthetic and/or blend of synthetic and natural fibers by fiber fusing or melting one or more surfaces with a flame or high heat from a burner heat source to eliminate or reduce the use of latex or other binders and low melt fibers. A first burner is positioned opposite a first roll around which the web passes, and the first burner applies a flame or heats the first surface. A second burner appropriately displaced from the first burner is positioned opposite a second roller around which the web passes and the second burner applies a flame or heats a second surface of the web. A blade or alternately a cylindrical assembly is positioned adjacent to each burner for flattening the melted fibers. An air nozzle is positioned immediately adjacent to each roller for cooling the entire width of a web as the web is heated to accomplish the melting of the predetermined necessary fibers without adversely affecting other fibers in the web.

### CROSS-REFERENCE TO RELATED APPLICATIONS

This is a nonprovisional patent application claiming priority of Provisional Application No. 60/611,499, filed Sep. 20, 2004 and Provisional Application No. 60/616,019 filed Oct. 5, 2004 both of which are incorporated herein by reference.

### BACKGROUND OF THE INVENTION

1. Field of the Invention

This invention relates generally to techniques for manufacturing woven and non-woven textile products such as a carpet fabric, and more particularly to a method and apparatus for fusing the back, front or both sides of woven or non-woven fabrics by fusing the surface on underlying areas with a controlled flame from a burner as a heat source.

2. Description of Related Art

Heat activated thermoplastic yarns have been used in the cuff edge of a glove for binding the cuff edge when heat activates the thermoplastic yarns and melting occurs as described in U.S. Pat. No. 4,842,611. Also, U.S. Pat. No. 4,488,928 discloses bulky absorbent webs are formed if bonded by heating low melt thermoplastic fibers of the web.

Traditionally carpet fibers or non-woven webs either synthetic and/or various blends (including cellulose) are stabilized by using latex and/or other products to achieve the same purpose. Closing pores in a fiber web can result in using less latex or stabilizing material which results in a cost savings to the web manufacturer.

Automotive and some other carpets use a blend of a low melt and poly fibers, and in order to lock or fuse the fibers after being mechanically bound by a needle-punching process. The web runs through specialized ovens in order to melt the more expensive low melt fiber and lock or fuse the poly-fibers within the web.

### SUMMARY OF THE INVENTION

Accordingly, it is therefore an object of this invention to provide a method and apparatus for producing less expensive non-woven fabric made from a combination of synthetic or blend of synthetic and natural fibers without low melt fibers or binders, by melting or fusing one or more surfaces with a flame or high heat burner heat source.

It is another object of this invention to increase the tuft bind and elongation of a non-woven fabric such as a carpet by melting one or more surfaces of the fabric.

It is yet another object of this invention to eliminate and/or reduce the amount of latex or other backing materials on a fabric such as a carpet, and therefore, reduce the cost of making such carpet.

It is another object of this invention to provide a method of fiber locking of a textile web or carpet by the application of a flame or high heat to melt the synthetic fibers, that the web is made of without the need of low melt fibers or any other binders on the back, front or both sides of the textile web or carpet.

It is another object of this invention to provide a method of fiber fusing that can be performed in line with a needlepunch machine for the production mechanical binding, the method not limited to eliminating the need for the handling of the web by a second process of latex binders, which saves labor costs and energy.

These and other objects are further accomplished by an apparatus for fiber fusing a surface of a fabric comprising a first roll positioned in the apparatus for receiving a fabric web and moving the fabric web around a portion of the first roll, a second roll positioned below and spaced apart from the first roll for receiving the web and moving the web around a portion of the second roll for exiting the apparatus, and a first burner, positioned adjacent to a side of and directed at the first roll which the web passes around a portion thereof, for applying a flame or heat to fibers of the web. The apparatus comprises a first blade positioned below the first roll and in contact with the web for flattening melted fibers after the web passes by the first burner. The apparatus comprises a first cylindrical assembly positioned below the first roll and in contact with the web for flattening melted fibers after the web passes by the first burner. The apparatus comprises a first air nozzle extending across a face of the web and positioned adjacent to the first roll for cooling the face of the web. The apparatus comprises a first gap adjuster for setting a fixed space between the web and the first blade. The apparatus comprises a first gap adjuster for setting a fixed space between the web and the first cylindrical assembly. The apparatus comprises a second burner, positioned adjacent to a side and directed at the second roll which the web passes around a portion thereof, for applying a flame or heat to fibers of the web. The apparatus comprises a second blade positioned below the second roll and in contact with the web for flattening melted fibers after the web passes by the second burner. The apparatus comprises a second cylindrical assembly positioned below the second roll and in contact with the web for flattening melted fibers after the web passes by the second burner. The apparatus comprises a second air nozzle extending across a face of the web and positioned adjacent to the second roll for cooling the face of the web.

The objects are further accomplished by an apparatus for fiber fusing a surface of a fabric comprising a first roll positioned in the apparatus for receiving a fabric web and moving the fabric web around a portion of the first roll, a second roll positioned below and spaced apart from the first roll for receiving the web and moving the web around a portion of the second roll for exiting the apparatus, a first burner, positioned adjacent to a side of and directed at the first roll which the web passes around a portion thereof, for applying a flame or heat to fibers of the web, a second burner, positioned adjacent to a side of and directed at the second roll which the web passes around a portion thereof, for applying a flame or heat to fibers of the web, a first means, positioned below the first roll and in contact with the web, for flattening melted fibers after the web passes by the first burner, a second means, positioned below the web, for flattening melted fibers after the web passes by the second burner, a first air source extending across a face of the web and positioned adjacent to the first roll for cooling the face of the web near the first burner, a second air source extending across a face of the web and positioned adjacent to the second roll for cooling the face of the web near the second burner, and the first burner being turned on for fusing a first surface of the web, and the second burner being turned on for fusing a second surface of the web.

The objects are further accomplished by a method of fiber fusing a surface of a fabric web comprising the steps of providing a first roll for receiving the fabric web and moving the fabric web around a portion of the first roll, positioning a second roll below and spaced apart from the first roll to receive the web and moving the web around a portion of the second roll for exiting the apparatus, and applying a flame or heat from a first burner to fibers of the web, the first burner being positioned adjacent to a side of the first roll which the web passes around. The method comprises the step of flattening melted fibers after the web passes by the first burner with a first blade positioned below the first roll and in contact with the web. The method comprises the step of flattening melted fibers after the web passes by the first burner with a first cylindrical assembly positioned below the first roll and in contact with the web. The method comprises the step of providing a first air nozzle extending across a face of the web and positioned adjacent to the first roll for cooling the face of the web. The method comprises the steps of providing a first gap adjuster for setting a fixed space between the web and the first blade. The method comprises the step of providing a first gap adjuster for setting a fixed space between the web and the first cylindrical assembly. The method comprises the step of applying a flame or heat from a second burner to fibers of the web, the second burner being positioned adjacent to a side of the second roll which the web passes around. The method comprises the step of flattening melted fibers after the web passes by the second burner with a second blade positioned below the second roll and in contact with the web. The method comprises the step of flattening melted fibers after the web passes by the second burner with a second cylindrical assembly positioned below the second roll and in contact with the web. The method comprises the step of providing an air nozzle extending across a face of the web and positioned adjacent to the second roll for cooling the face of the web.

The objects are further accomplished by a method of fiber fusing a surface of a fabric web comprising the steps of providing a first roll for receiving the fabric web and moving the fabric web around a portion of the first roll, positioning a second roll below and spaced apart from the first roll to receive the web and moving the web around a portion of the second roll for exiting the apparatus, applying a flame or heat from a first burner to fibers of the web, the first burner being positioned adjacent to a side of the first roll which the web passes around, applying a flame or heat from a second burner to fibers of the web, the second burner being positioned adjacent to a side of the second roll which the web passes around, flattening melted fibers after the web passes by the first burner with first means positioned below the first roll and in contact with the web, flattening melted fibers after the web passes by the second burner with second means positioned below the second roll and in contact with the web, providing a first air source extending across a face of the web and positioned adjacent to the first roll for cooling the face of the web, providing a second air source extending across a face of the web and positioned adjacent to the roll for cooling the face of the web, and turning on the first burner when fusing a first surface of the web, and turning on the second burner when fusing a second surface of v web. The step of flattening melted fibers with first means below the first roll and with second means below the second roll comprises the steps of providing a first blade below the first roll in contact with the web and providing a second blade below the second roll in contact with the web. The step of flattening melted fibers with first means below the first roll and with second means below the second roll comprises the steps of providing a first cylindrical assembly below the first roll in contact with the web and providing a second cylindrical assembly below the second roll in contact with the web.

Additional objects, features and advantages of the invention will become apparent to those skilled in the art upon consideration of the following detailed description of the preferred embodiments exemplifying the best mode of carrying out the invention as presently perceived.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is a schematic representation of a side view of an apparatus for fiber fusing one or more sides of a surface of woven or non-woven fabric according to the present invention.

FIG.2 is a schematic representation of a side view of the apparatus for fiber fusing a fabric showing a blade for flattening melted fibers and an air nozzle for cooling the web.

FIG. 3A shows a graphical representation of an unprocessed web fabric.

FIG. 3B shows a graphical representation of fabric having melted fibers on a lower surface according to the present invention.

FIG. 4 is a schematic representation of a side view of an alternate embodiment of the apparatus for fiber fusing a fabric having cylindrical rolls for flattening the melted fibers.

### DESCRIPTION OF ILLUSTRATIVE EMBODIMENT

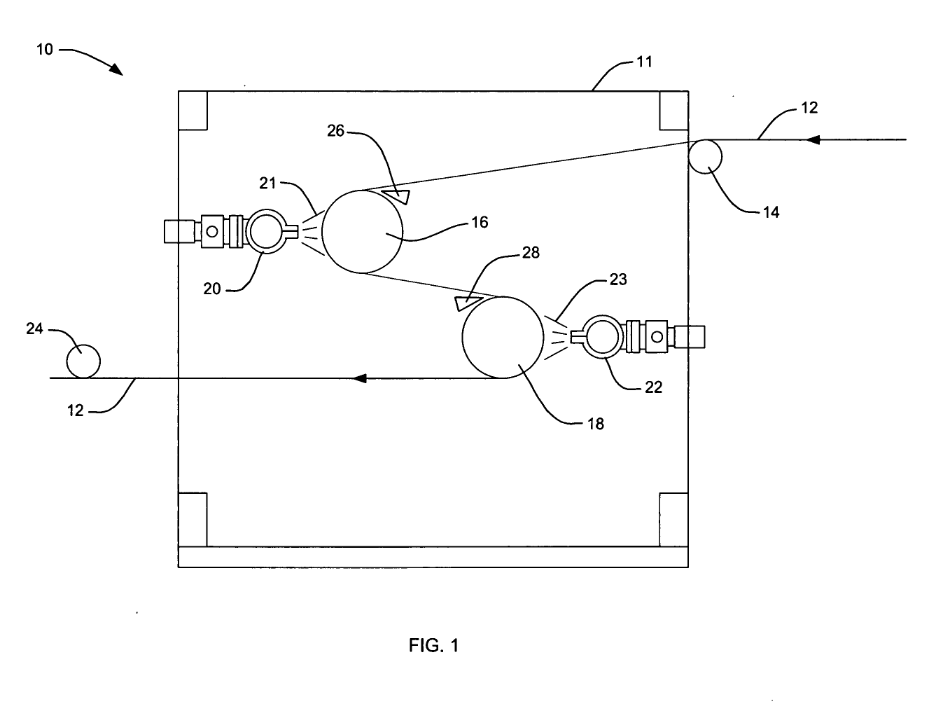

Referring to FIG. 1, a schematic representation is shown of a side view of an apparatus 10 for fiber fusing and fiber locking one or more sides of a web 12 of woven or non-woven fabric according to the present invention. The non-woven fabric may be produced from synthetic and/or some blends of synthetic and natural fibers that may or may not be mechanically bound together by a needlepunch process. The web 12 of a fabric comprises a synthetic and/or blend of synthetic and natural fibers. In addition, the web fabric may include a flame retardant fiber and/or an antimicrobial fiber. The apparatus 10 melts the exposed and predetermined percentage of fibers in the web 10 with burners 20, 22 having an open flame 21, 23 or high heat output which results in increasing the tuft bind and elongation of the web of non-woven fabrics, such as a carpet. The web 12 of a non-woven fabric or another article after passing through apparatus 10 results in a product that has a strong melted backing composition which exhibits excellent dimension stability, strong bonding to the web substrate and low resistant tack. The apparatus 10 results in eliminating or reducing the amount of latex or other similar bonding materials used in the prior art because of the synthetic fibers and/or some blends and natural fibers melting ability.

Still referring to FIG. 1, a small diameter directional roller 14 guides the web 12 from a mechanical binding apparatus such as a needlepunch loom or from an unwind stand if the fiber locking is a separate process with a product roll (not shown) directed toward a water cooled roll 16, and then the web 12 passes around a portion of the roll 16. The rolls 16, 18 can be turned by the friction of the web 12 or turn assisted by a drive commonly know in the art. Positioned on the left side of roll 16 is a first burner 20 which extends across the face of the roll 16 and emits a flame or high heat directed to the web 12. A second water cooled roll 18 is positioned below and to the right of roll 16, and the web 12 passes around a portion of roll 18 after leaving roll 16 and then exits the apparatus 10 via a guide roller 24 to a product take-up roll of a winding machine (not shown). Positioned on the right side of roll 18 is a second burner 22 which extends across the width of web 12 and emits a flame or high heat directed to the web 12 as it passes around a portion of roll 18. The first burner 20 is turned on to heat and melt fibers on a first side of the web 12, and the second burner 22 is turned on when required to heat and melt fibers on a second side of the web 12. First burner 20 and second burner 22 may both be turned on simultaneously or only one of then may be turned on depending on requirements for the fabric being processed. The burners 20, 22 may be embodied by Part No. 329 with sheet ribbon assembly 9RV/4F manufactured by Ensign Ribbon Burners, LLC of Pelham Manor, N.Y. 10803. The water cooled rolls 16, 18 may be embodied by Part No. SSR-35 manufactured by WEBMAN of South Carolina of Mayo, S.C.

A first air nozzle 26 is positioned adjacent to the roll 16 aimed at the surface of the web 12 that touches the roll 16. The air nozzle 26 extends across the face of the web 12 in order to cool the surface of the web 12 that is not treated by the burner 20. The use of the air nozzle 26 is to avoid the chance of distortion (melting and/or flattening) of the non-treated (at the time) side of the web, regardless of the amount of flame needed at the time for the fiber-locking process of the web 12.

The air nozzle 26 is mounted by bolting it on the sides (walls) 11 of the apparatus 10. The source of air is supplied by a fan, blower or compressed air from both sides of the nozzle or just one, depending on the width of the apparatus 10.

Likewise, a second air nozzle 28 is positioned adjacent to the roll 18 aimed at the surface of the web 12 that touches the roll 18. The air nozzle 28 extends across the face of the web 12 in order to cool the non-treated side of the web 12 in case the amount of flame 23 from the burner 22 has to be increased to a higher required level for treating the web running at the time. The 329 w/sheet ribbon assembly 9RV/4F delivers a maximum of 2,800 BTU's in/hr and a minimum of 700 BTU's in/hr. Typical automotive carpet requires for fiber fusing, that the apparatus 10 operates at 20 F.P.M. and approximately 2,200 BTU's in/hr. These operating numbers change depending on the web's speed, type of fiber and amount of fiber locking required. The air nozzle may be embodied by Part No. ANZ-37 manufactured by WEBMAN of South Carolina of Mayo, S.C.

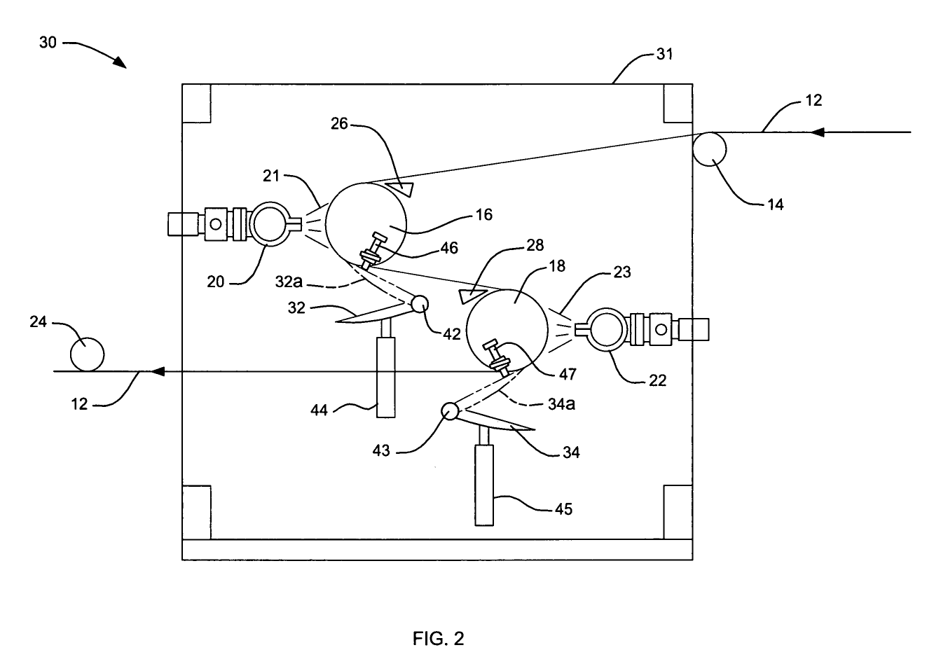

Referring to FIG. 2, a schematic representation is shown of a side view of an apparatus 30 for fiber fusing a fabric. Apparatus 30 comprises the same elements as apparatus 10 in FIG. 1 having the same reference numbers, with the addition of a first blade 32 positioned immediately after the web 12 leaves roll 16, and a second blade 34 positioned immediately after the web 12 leaves roll 18. The first blade 32 is movable about an end 42; in an operating mode, the first blade 32 is positioned by an arm 44 so that it touches the web 12, which is illustrated in FIG. 2 by dashed lines 32a, and flattens the melted fibers on the surface of the web 12 and produces bonding of more fibers. In a standby mode or threading mode, the first blade 32 is moved away from the roll 16 thereby allowing a web 12 to be removed from apparatus 30 or a new web inserted therein. Likewise, the second blade 34 is movable about an end 43; in an operating mode, the second blade 34 is positioned by an arm 45 so that it touches the web 12, which is illustrated in FIG. 2 by dashed lines 34a, and flattens the melted fibers on the surface of the web 12 as well as bonding more fibers together. As shown in FIG. 2, a first blade 32 touches one surface of the web 12 and when required, the second blade 34 touches an opposite surface of the web 12. In a standby or threading mode, the second blade 34 is moved away from the roll 18. Gap adjusting elements 46, 47 may be added to the apparatus 30 to establish fixed gaps for the web 12 to pass by the blade 32 and 34 for the fiber fusing of certain fabrics such as automotive carpet which needs a gap of 0.187 inches. A flat steel bar (not shown) holds the gap adjusting elements 46, 47, and is welded on the wall 31 of the apparatus 30. The pivot point of the blades 32 and 34 are welded on the wall 31 of the apparatus 30. The blades are made out of steel and Teflon coated, if needed, and the arm is made of steel. If floating blades 32 and 34 are preferred, the gap adjusting elements 46, 47 are removed. The blades 32, 34 may be embodied by Part No. BL-32 manufactured by WEBMAN of South Carolina of Mayo, S.C.

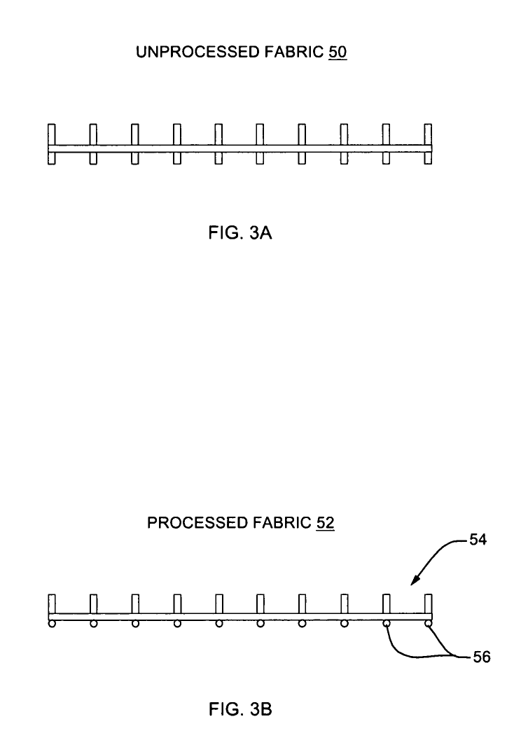

Referring to FIG. 3A and FIG. 3B, FIG. 3A shows a graphical representation of an unprocessed web fabric 50, having upper and lower surfaces which are not yet processed by the present invention. FIG. 3B shows a graphical representation of a processed web fabric 52 having upper surface 54 and melted fibers on a lower surface indicated by round balls 56 according to the present invention. The effect produced by the melted fibers or round balls 56 is eliminated by the blades 32 or 34 which flatten the round balls 56 on the surface of the web fabric 52 that either blade 32 or 34 contacts.

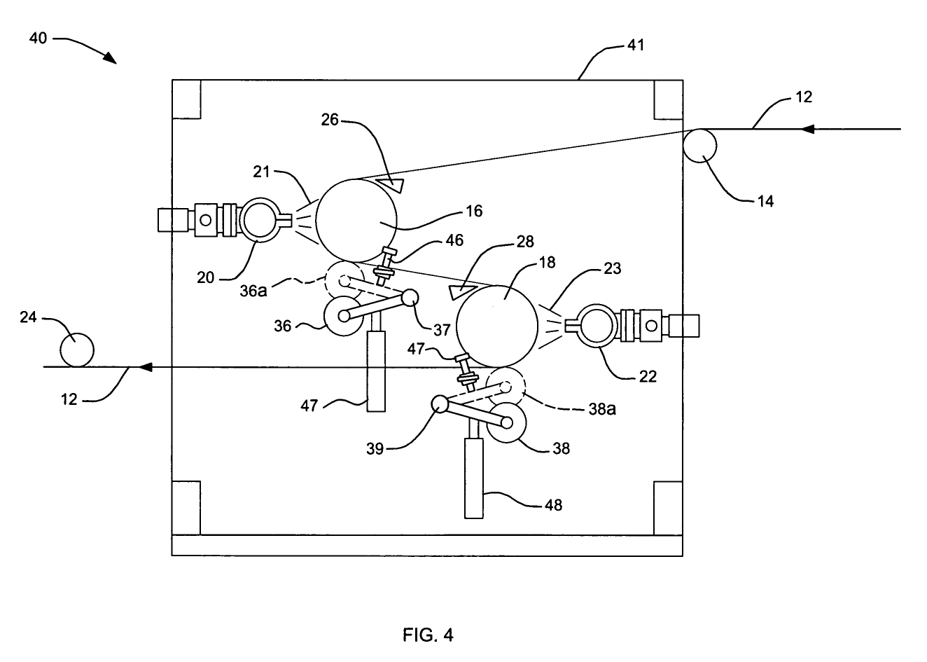

Referring to FIG. 4, a schematic representation is shown of a side view of an alternate embodiment identified as apparatus 40 for fiber fusing a fabric web 12 having an assembly comprising cylindrical rolls 36, 38 for flattening melted fibers. The apparatus 40 comprises the same first and second water cooled rolls 16, 18, the same first and second burners 20, 22 and the same first and second air nozzles 26, 28, as described above for apparatus 30, but instead of blades 32, 34, apparatus 40 comprises the assemblies of first and second cylindrical rolls 36, 38. The cylindrical rolls 36, 38 pivot about ends 37, 39 respectively and steel arms 47 and 49 move the cylindrical rolls 36, 38 from a standby mode or a thread-up mode to an operating mode, which is illustrated in FIG. 4 by the dashed lines 36a and 36b, where they are able to flatten the melted fibers on a surface of the web 12. Gap adjusting elements 46, 47 may be added to the assemblies of cylindrical rolls 36, 38 to provide a fixed gap depending on the thickness of the web 12 to enable the web 12 to pass by the cylindrical rolls 36, 38 for the fiber fusing of certain fabrics such as outdoor carpets, synthetic upholstery, but not limited to them. If floating cylindrical rolls 36, 38 are preferred, the gap adjusting elements 46, 47 are removed.

The method of fiber fusing a fabric employing the apparatus shown in FIGS. 1, 2, and 4 is provided for binding the back, front or both sides of woven, non-woven, either horizontally or vertically lapped, textile products primarily for but not limited to carpets, by melting the surface or underlying area with a flame or high heat source provided by burners 20 and 22. This method creates a textile product having unique and very strong backing which exhibits excellent dimensional stability, strong bonding to the substrate and low residual tack (not sticky) after the product has cooled off.

In addition, this method provides a melted composition which is more easily processed than polyurethane forming compositions which are conventionally employed to prepare textile backings and which provide the desired dimensional stability, tack and adhesion. The use of the external heat source such as burners 16 and 18 which provides both exceptional tuft and elongation also improves crack resistance of the created backing. The method eliminates the traditional approach to stabilize carpet fibers, woven or non-woven webs, either synthetic (man made) and/or various blends (including cellulose) using latex and/or other products to achieve the same purpose.

This method also encompasses the ability to vary the degree of fiber locking by increasing or decreasing the flame 21, 23 providing high heat or by guiding the web 12 around various diameter rolls such as 8″, 6″, 5″, and 4″, but not limited to these sizes, depending on the web's width. In an alternate embodiment, the rolls 16, 18 may be replaced with bars, if the friction and tension on the web 12 can be tolerated. Thus, the smaller the diameter of the roll the web 12 travels around, the web 12 becomes more open and allows an increase in the amount of flame or heat to penetrate the fibers of the web 12. In addition, the speed the web 12 travels through the apparatus 10, 30, and 40 may be used to adjust the amount of fiber fusion.

On various blends of synthetic fibers and natural fibers, the method using the apparatus 30, 40 in FIG. 2 and FIG. 4 creates the desired backing by melting the synthetic fibers and then passing the web 12 through a nip or gap with a smooth or textured cylindrical roll 36, 38 while the web fabric is still hot in order to totally flatten and bond the natural fibers with the melted synthetic fiber.

The method of fiber fusing a fabric web 12 comprises the steps of:
(a) providing the fabric web 12 to a first water cooled roll 16;
(b) threading the web 12 around a portion of the first water cooled roll 16 (or a stationary bar if web's tension allows it) and between the roll 16 and a first blade 32 under the roll 16 for flattening melted fibers;
(c) threading web 12 around a portion of the second water cooled roll 18 (or a stationary bar if web's tension allows it) and between roll 18 and a second blade 34 under roll 18 for flattening melted fiber, of said fabric web 12 being processed;
(d) positioning a first burner 16 aimed at the web 12 as it goes around a portion of the first roll 16 to apply a predetermined flame or heat to the web 12, according to a particular fabric web 12 being processed;
(e) positioning a second burner 22 aimed at the web 12 as it goes around a portion of the second roll 18 to apply a predetermined flame or heat to the web 12, according to said particular fabric web 12 being processed;
(f) positioning a first air nozzle to cool the web 12 as the web 12 contacts the first roll 18, as required for the particular fabric web 12 being processed; and
(g) positioning a second air nozzle to cool the web 12 as the web contacts the second roll 18, as required, for the particular fabric web being processed.

The above method enables various types of fabric webs to undergo fiber fusing on one or more sides, at various speeds and at various heating temperatures as required to accomplish the correct amount of fiber fusing. For example, when a fabric web 12 requires fiber fusing on only one main surface, only one of the burners 20, 22 will be ON, and only the blade associated with the ON burner will be touching the web 12. When a fabric web 12 requires fiber fusing on two opposite surfaces, then both burners 20, 22 will be turned ON and both blades 32, 34 will be touching the web 12 for flattening the melted fibers after the web 12 passes each burner 20, 22.

This invention has been disclosed in terms of certain embodiments. It will be apparent that many modifications can be made to the disclosed apparatus without departing from the invention. Therefore, it is the intent of the appended claims to cover all such variations and modifications as come within the true spirit and scope of this invention.

What is claimed is:

1. An apparatus for fiber fusing a surface of a fabric comprising:
(a) a first roll positioned in said apparatus for receiving a fabric web and moving said fabric web around a portion of said first roll;
(b) a second roll positioned below and spaced apart from said first roll for receiving said web and moving said web around a portion of said second roll for exiting said apparatus; and
(c) a first burner, positioned adjacent to a side of and directed at said first roll which said web passes around a portion thereof, for applying a flame or heat to fibers of said web.

2. The apparatus as recited in claim 1 wherein said apparatus comprises a first blade positioned below said first roll and in contact with said web for flattening melted fibers after said web passes by said first burner.

3. The apparatus as recited in claim 1 wherein said apparatus comprises a first cylindrical assembly positioned below said first roll and in contact with said web for flattening melted fibers after said web passes by said first burner.

4. The apparatus as recited in claim 1 wherein said apparatus comprises a first air nozzle extending across a face of said web and positioned adjacent to said first roll for cooling said face of said web.

5. The apparatus as recited in claim 2 wherein said apparatus comprises a first gap adjuster for setting a fixed space between said web and said first blade.

6. The apparatus as recited in claim 3 wherein said apparatus comprises a first gap adjuster for setting a fixed space between said web and said first cylindrical assembly.

7. The apparatus as recited in claim 1 wherein said apparatus comprises a second burner, positioned adjacent to a side and directed at said second roll which said web passes around a portion thereof, for applying a flame or heat to fibers of said web.

8. The apparatus as recited in claim 7 wherein said apparatus comprises a second blade positioned below said second roll and in contact with said web for flattening melted fibers after said web passes by said second burner.

9. The apparatus as recited in claim 7 wherein said apparatus comprises a second cylindrical assembly positioned below said second roll and in contact with said web for flattening melted fibers after said web passes by said second burner.

10. The apparatus as recited in claim 7 wherein said apparatus comprises a second air nozzle extending across a face of said web and positioned adjacent to said second roll for cooling said face of said web.

11. The apparatus as recited in claim 8 wherein said apparatus comprises a second gap adjuster for setting a fixed space between said web and said second blade.

12. The apparatus as recited in claim 8 wherein said apparatus comprises a second gap adjuster for setting a fixed space between said web and said second cylindrical assembly.

13. An apparatus for fiber fusing a surface of a fabric comprising:
(a) a first roll positioned in said apparatus for receiving a fabric web and moving said fabric web around a portion of said first roll;
(b) a second roll positioned below and spaced apart from said first roll for receiving said web and moving said web around a portion of said second roll for exiting said apparatus;
(c) a first burner, positioned adjacent to a side of and directed at said first roll which said web passes around a portion thereof, for applying a flame or heat to fibers of said web;
(d) a second burner, positioned adjacent to a side of and directed at said second roll which said web passes around a portion thereof, for applying a flame or heat to fibers of said web;
(e) a first means, positioned below said first roll and in contact with said web, for flattening melted fibers after said web passes by said first burner;
(f) a second means, positioned below said web, for flattening melted fibers after said web passes by said second burner;
(g) a first air source extending across a face of said web and positioned adjacent to said first roll for cooling said face of said web near said first burner;
(h) a second air source extending across a face of said web and positioned adjacent to said second roll for cooling said face of said web near said second burner; and
(i) said first burner being turned on for fusing a first surface of said web, and said second burner being turned on for fusing a second surface of said web.

14. The apparatus as recited in claim 13 wherein said first flattening means comprises a first blade and said second flattening means comprises a second blade.

15. The apparatus as recited in claim 13 wherein said first flattening means comprises a first cylindrical assembly and said second flattening means comprises a second cylindrical assembly.

16. A method of fiber fusing a surface of a fabric web comprising the steps of:
(a) providing a first roll for receiving said fabric web and moving said fabric web around a portion of said first roll;
(b) positioning a second roll below and spaced apart from said first roll to receive said web and moving said web around a portion of said second roll for exiting said apparatus; and
(c) applying a flame or heat from a first burner to fibers of said web, said first burner being positioned adjacent to a side of said first roll which said web passes around.

17. The method as recited in claim 16 wherein said method comprises the step of flattening melted fibers after said web passes by said first burner with a first blade positioned below said first roll and in contact with said web.

18. The method as recited in claim 16 wherein said method comprises the step of flattening melted fibers after said web passes by said first burner with a first cylindrical assembly positioned below said first roll and in contact with said web.

19. The method as recited in claim 16 wherein said method comprises the step of providing a first air nozzle extending across a face of said web and positioned adjacent to said first roll for cooling said face of said web.

20. The method as recited in claim 17 wherein said method comprises the steps of providing a first gap adjuster for setting a fixed space between said web and said first blade.

21. The method as recited in claim 18 wherein said method comprises the step of providing a first gap adjuster for setting a fixed space between said web and said first cylindrical assembly.

22. The method as recited in claim 16 wherein said method comprises the step of applying a flame or heat from a second burner to fibers of said web, said second burner being positioned adjacent to a side of said second roll which said web passes around.

23. The method as recited in claim 22 wherein said method comprises the step of flattening melted fibers after said web passes by said second burner with a second blade positioned below said second roll and in contact with said web.

24. The method as recited in claim 22 wherein said method comprises the step of flattening melted fibers after said web passes by said second burner with a second cylindrical assembly positioned below said second roll and in contact with said web.

25. The method as recited in claim 22 wherein said method comprises the step of providing an air nozzle extending across a face of said web and positioned adjacent to said second roll for cooling said face of said web.

26. The method as recited in claim 23 wherein said method comprises the step of providing a first gap adjuster for setting a fixed space between said web and said second blade.

27. The method as recited in claim 23 wherein said method comprises the step of providing a second gap adjuster for setting a fixed space between said web and said second cylindrical assembly.

28. A method of fiber fusing a surface of a fabric web comprising the steps of:
(a) providing a first roll for receiving said fabric web and moving said fabric web around a portion of said first roll;
(b) positioning a second roll below and spaced apart from said first roll to receive said web and moving said web around a portion of said second roll for exiting said apparatus;
(c) applying a flame or heat from a first burner to fibers of said web, said first burner being positioned adjacent to a side of said first roll which said web passes around;
(d) applying a flame or heat from a second burner to fibers of said web, said second burner being positioned adjacent to a side of said second roll which said web passes around;
(e) flattening melted fibers after said web passes by said first burner with first means positioned below said first roll and in contact with said web;
(f) flattening melted fibers after said web passes by said second burner with second means positioned below said second roll and in contact with said web;
(g) providing a first air source extending across a face of said web and positioned adjacent to said first roll for cooling said face of said web;
(h) providing a second air source extending across a face of said web and positioned adjacent to said roll for cooling said face of said web; and
(i) turning on said first burner when fusing a first surface of said web, and turning on said second burner when fusing a second surface of said web.

29. The method and apparatus as recited in claim 28 wherein said step of flattening melted fibers with first means below said first roll and with second means below said second roll comprises the steps of providing a first blade below said first roll in contact with said web and providing a second blade below said second roll in contact with said web.

30. The method as recited in claim 28 wherein said step of flattening melted fibers with first means below said first roll and with second means below said second roll comprises the steps of providing a first cylindrical assembly below said first roll in contact with said web and providing a second cylindrical assembly below said second roll in contact with said web.

31. A method of fiber fusing a fabric web comprising the steps of:
(a) providing said fabric web to a first roll;
(b) threading said web around a portion of said first roll and between said roll and a first blade under said roll for flattening melted fibers;
(c) threading said web around a portion of second roll and between said second roll and a second blade under said second roll for flattening melted fiber of said fabric web;
(e) positioning a first burner aimed at said web as said web goes around a portion of said first roll to apply a predetermined flame or heat to said web according to a particular fabric web being processed;
(f) positioning a second burner aimed at said web as it goes around a portion of said second roll to apply a predetermined flame or heat to said web according to said particular fabric web being processed;
(g) positioning a first air nozzle to cool, as required, said web as said web contacts said first roll for said particular fabric web being processed;
(h) positioning a second air nozzle to cool, as required, said web as said web contacts said second roll for said particular fabric web being processed; and
(i) turning on said first burner when fusing a first surface of said web, and turning on said second burner when fusing a second surface of said web.
